(19) United States
(12) Patent Application Publication
(10) Pub. No.: US 2020/0301517 A1
(43) Pub. Date: Sep. 24, 2020

(54) INPUT DEVICE WITH CAPACITIVE TOUCH AND PROXIMITY SENSING

(71) Applicant: Cirque Corporation, Salt Lake City, UT (US)

(72) Inventors: BRIAN D. MONSON, Farmington, UT (US); JARED G. BYTHEWAY, Sandy, UT (US)

(21) Appl. No.: 16/356,847

(22) Filed: Mar. 18, 2019

(51) Int. Cl. G06F 3/02; G06F 3/044; G06F 3/0338; A63F 13/214; A63F 13/24

(52) U.S. Cl. CPC G06F 3/021; G06F 3/044; G06F 3/0338; A63F 2300/1068; A63F 13/24; A63F 2300/8082; A63F 2300/1043; A63F 13/214

(57) ABSTRACT

Input devices including touch sensor systems and methods are disclosed for use in virtual reality (VR) or augmented reality (AR) systems and environments.

### FIELD OF THE DISCLOSURE

This disclosure relates generally to touch sensing input devices and methods of operation. More particularly, this disclosure relates to systems and methods for touch sensing input devices to locate an input device user's hands or fingers on or near the device.

### BACKGROUND

In many situations input devices, such as keyboards, game controllers, joysticks, directional pads (D-pads), and the like need to be used without the user being able to view the input device. For example, in virtual reality (VR) or augmented reality (AR) environments, a headset, helmet, goggles, or the like often precludes or limits viewing of the input device. Some existing systems have provided a camera or the like to augment the users view of the input device, however, these systems can be unduly complicated and expensive to implement. Other drawbacks, inconveniences, and issues with existing devices and methods also exist.

### SUMMARY

Accordingly, disclosed embodiments address the above-noted, and other, drawbacks, inconveniences, and issues with existing devices and methods. Disclosed embodiments include an input device for a VR or AR system, the input device having at least one input controller for providing user input to the VR or AR system, and a touch sensor adjacent to the at least one input controller and configurable to sense an object touching or proximate to the at least one input controller.

In further disclosed embodiments, the input device is a keyboard and the at least one input controller is a key. In further disclosed embodiments, the touch sensor is located beneath the key. In still further embodiments, the touch sensor is located within the key. In still further embodiments, the touch sensor is located on a top surface of the key. In still further embodiments, the touch sensor is an in-mold conductive plastic.

In further disclosed embodiments, the input device is a keyboard that has a wrist rest region and a second touch sensor located within the wrist rest region that is configurable to sense an object touching or proximate to the wrist rest region. In further disclosed embodiments, the second touch sensor is a capacitive touch sensor.

Further disclosed embodiments, include a keyboard having a plurality of keys and a touch sensor associated with each of the plurality of keys and that senses a touch or proximity of a user's finger on specific ones of the plurality of keys. In further disclosed embodiments, the touch sensor includes a touch sensor substrate positioned beneath the plurality of keys, and a plurality of electrodes on the touch sensor substrate and positioned to substantially outline a perimeter of each of the plurality of keys.

Further disclosed embodiments include a game controller for a VR or AR system, the game controller including at least one input controller for providing user input to the VR or AR system, and a touch sensor adjacent to the at least one input controller and configurable to sense an object touching or proximate to the at least one input controller.

In further disclosed embodiments, the at least one input controller is a button. In further disclosed embodiments, the touch sensor is located within the button. In still further embodiments, the touch sensor is located on a top surface of the button. In still further embodiments, the touch sensor comprises in-mold conductive plastic. In still further embodiments, the at least one input controller comprises a joystick. Other advantages, conveniences, and embodiments are also possible.

### BRIEF DESCRIPTION OF THE DRAWINGS

FIG. 1 is a schematic block diagram of an example of a capacitive touchpad system.

FIG. 2 is a schematic of an input device with capacitive touch sensors in accordance with disclosed embodiments.

FIG. 3 is a schematic illustration of an input device with capacitive touch sensors in accordance with disclosed embodiments.

FIG. 4 is an exploded, schematic, cross-sectional illustration of a portion of an input device with capacitive touch sensors in accordance with disclosed embodiments.

FIG. 5 is a schematic illustration of an input device of the type shown in FIG. 4 showing exemplary electrode routing for capacitive touch sensors in accordance with disclosed embodiments.

FIG. 6 is an exploded, schematic, cross-sectional illustration of a portion of an input device with capacitive touch sensors in accordance with disclosed embodiments.

FIG. 7 is a schematic diagram of an input device of the type shown in FIG. 6 showing exemplary locations of capacitive touch sensors in accordance with disclosed embodiments.

FIG. 8 is a schematic diagram of a system implementing a VR or AR input device with capacitive touch sensing in accordance with disclosed embodiments.

While the disclosure is susceptible to various modifications and alternative forms, specific embodiments have been shown by way of example in the drawings and will be described in detail herein. However, it should be understood that the disclosure is not intended to be limited to the particular forms disclosed. Rather, the intention is to cover all modifications, equivalents and alternatives falling within the spirit and scope of the invention as defined by the appended claims.

### DETAILED DESCRIPTION

It should be understood that use of the terms “touch pad” and “touch sensor” throughout this document may be used interchangeably with “capacitive touch sensor,” “capacitive sensor,” “capacitive touch and proximity sensor,” “proximity sensor,” “touch and proximity sensor,” “touch panel,” “touchpad,” and “touch screen.”

It should also be understood that, as used herein, the terms “vertical,” “horizontal,” “lateral,” “upper,” “lower,” “left,” “right,” “inner,” “outer,” etc., can refer to relative directions or positions of features in the disclosed devices and/or assemblies shown in the Figures. For example, “upper” or “uppermost” can refer to a feature positioned closer to the top of a page than another feature. These terms, however, should be construed broadly to include devices and/or assemblies having other orientations, such as inverted or inclined orientations where top/bottom, over/under, above/below, up/down, and left/right can be interchanged depending on the orientation.

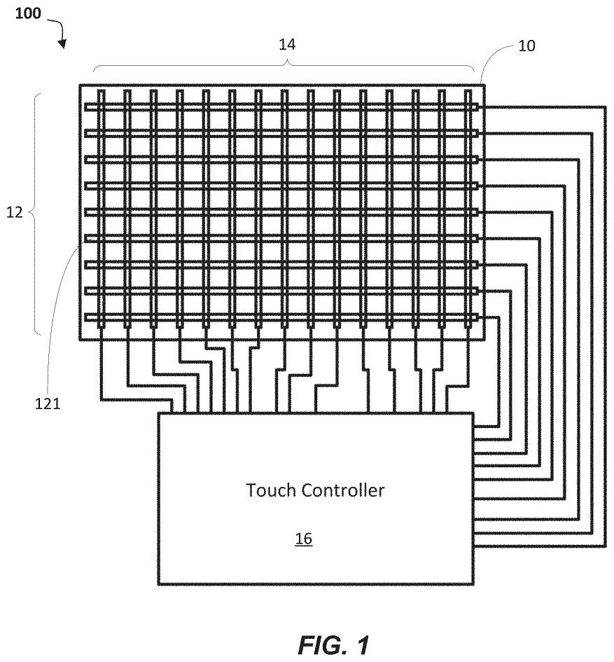

The present invention utilizes touchpad technology from CIRQUE® Corporation. Accordingly, it is useful to understand operation of the touchpad technology to a degree. The touchpad technology from CIRQUE® Corporation is a mutual capacitance sensing device 100 and an example is illustrated in FIG. 1. For this device 100 a touchpad 10 having a grid of row 12 and column 14 electrodes is used to define the touch-sensitive area of the touchpad 10. Typically, the touchpad is configured as a rectangular grid of an appropriate number of electrodes (e.g., 8-by-6, 16-by-12, 9-by-15, or the like).

As shown in FIG. 1, the mutual capacitance sensing device 100 also includes a touch controller 16. Touch controller 16 typically includes at least one of a central processing unit (CPU), a digital signal processor (DSP), an analog front end (AFE) including amplifiers, a peripheral interface controller (PIC), another type of microprocessor, and/or combinations thereof, and may be implemented as an integrated circuit, a field programmable gate array (FPGA), an application specific integrated circuit (ASIC), a combination of logic gate circuitry, other types of digital or analog electrical design components, or combinations thereof, with appropriate circuitry, hardware, firmware, and/or software to choose from available modes of operation.

Typically, touch controller 16 also includes at least one multiplexing circuit to alternate which of the row 12 or column 14 electrodes are operating as a drive electrode or a sense electrode. The driving electrodes can be driven one at a time in sequence, or randomly, or all at the same time in encoded patterns. Other configurations are possible such as self-capacitance mode where the electrodes are driven and sensed simultaneously. Electrodes may also be arranged in non-rectangular arrays, such as radial patterns, linear strings, or the like. Other configurations are also possible.

Typically, no fixed reference point is used for measurements. Touch controller 16 generates signals that are sent directly to the row 12 and column 14 electrodes in various patterns.

The touchpad 10 does not depend upon an absolute capacitive measurement to determine the location of a finger (or stylus, pointer, or other object) on the touchpad 10 surface. The touchpad 10 measures an imbalance in electrical charge to the electrode functioning as a sense electrode (exemplarily illustrated as row electrode 121 in FIG. 1, but can be any of the row 12, column 14, or other dedicated-sense electrodes). When no pointing object is on or near the touchpad 10, the touch controller 16 is in a balanced state, and there is no signal on the sense electrode (e.g., electrode 121). When a finger or other pointing object creates imbalance because of capacitive coupling, a change in capacitance occurs on the plurality of electrodes 12, 14 that comprise the touchpad electrode grid. What is measured is the change in capacitance, and not the absolute capacitance value on the electrodes 12, 14.

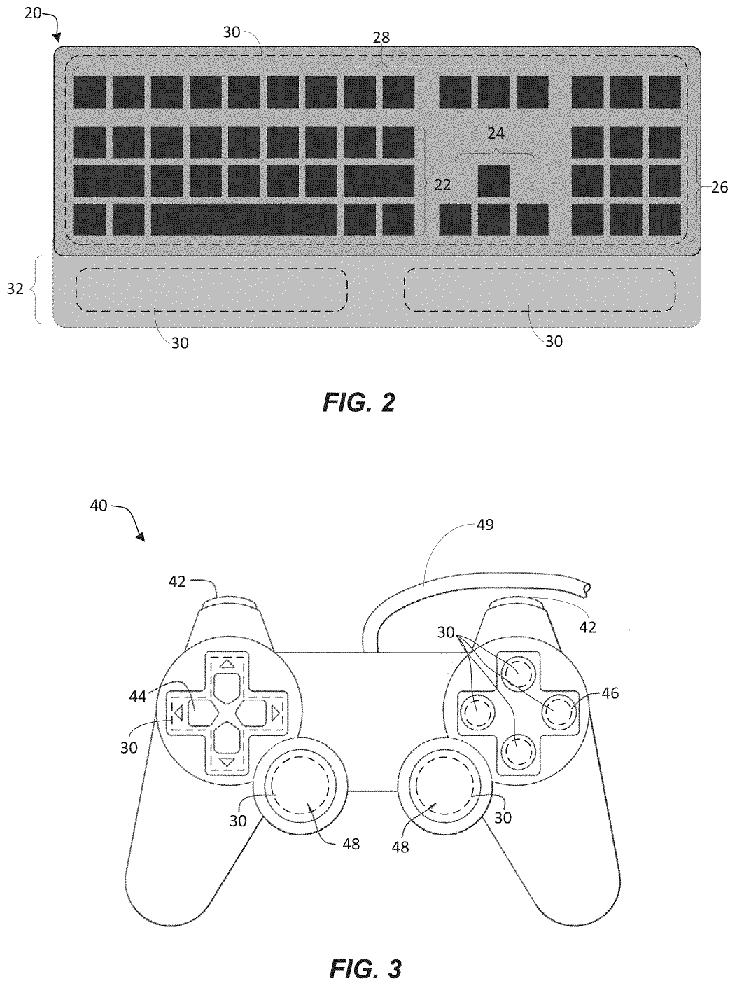

FIG. 2 is a schematic of an input device with capacitive touch sensors in accordance with disclosed embodiments. As shown input device may comprise a keyboard 20 with a typical QWERTY layout for alphabet keys 22, directional keys 24, numeric keys 26, function keys 28, and the like. Of course, as one of ordinary skill in the art having the benefit of this disclosure would understand, other layouts (e.g., ergonomic or split layouts), key arrangements, types of keys, key functions, number of keys, and the like, may be used. As disclosed herein, keyboard 20 includes touch sensors underneath, or incorporated within, the keyboard as indicated by touch sensor region 30. Additionally, some keyboards (e.g., laptop keyboards) may include a wrist rest region 32 that includes additional touch sensor regions 30. In some embodiments, touch sensors 30 may comprise proximity sensing sensors to detect when a user's hands are near (i.e., in proximity to) a touch sensor region 30. This is particularly useful for touch sensors 30 in the wrist rest region 32 where a user will often rest or hover their hands without touching the keys.

FIG. 3 is a schematic illustration of another input device with capacitive touch sensors in accordance with disclosed embodiments. As shown in FIG. 30, an input device may also comprise a game controller 40 with left and right front buttons 42, a directional pad 44, A-B-X-Y selection buttons 46, left and right joysticks 48, and the like. Of course, as one of ordinary skill in the art having the benefit of this disclosure would understand, other configurations for game controller 40, button arrangements, types of buttons, button functions, number of buttons, and the like, may be used. Game controller 40 is indicated as being wired 49, but need not be so, and the disclosed embodiments include wireless controllers 40 as well. As also indicated, each region of the game controller may include touch sensors 30 as exemplarily indicated for joysticks 48 and directional pad 44. As disclosed above for keyboard 20, the touch sensors 30 may be underneath the surfaces of, or integrated into, the various buttons, joysticks, and the like on the game controller 40. Touch sensors 30 can also be integrated into various locations of the game controller 40 housing.

While FIGS. 2-3 show exemplary input devices of a keyboard 20 and game controller 40, one of ordinary skill in the art having the benefit of this disclosure would understand other input devices such as steering wheels, cockpit joysticks, sporting game paddles, rackets, fishing poles, fighting game weapons, and the like may also be implemented as disclosed herein.

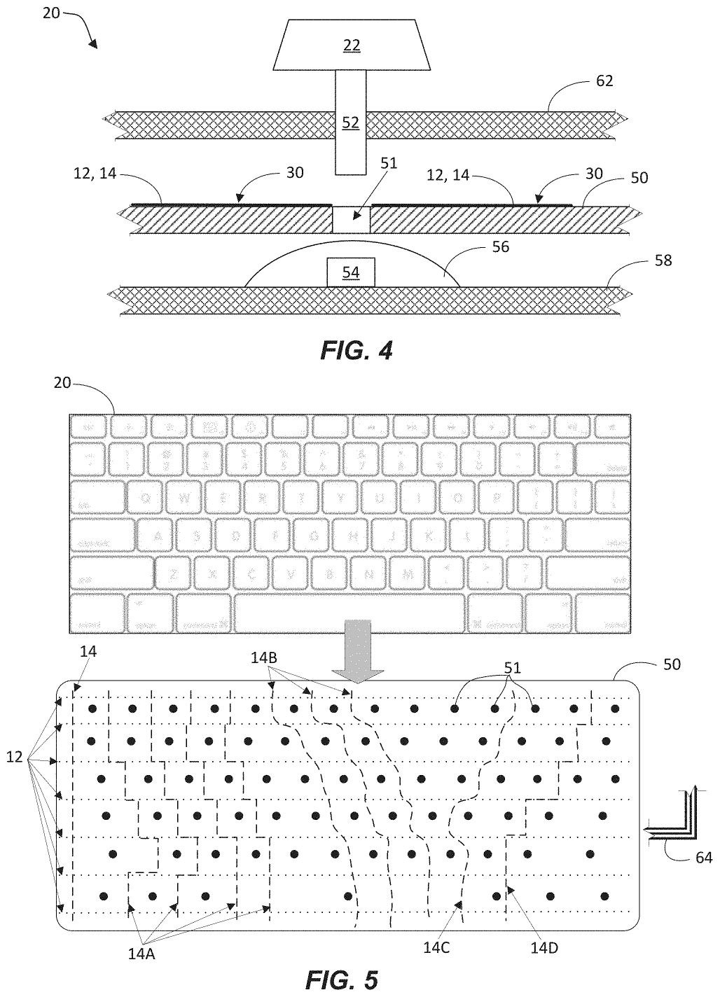

FIG. 4 is an exploded, schematic, cross-sectional illustration of a portion of an input device with capacitive touch sensors 30 in accordance with disclosed embodiments. As shown in close-up, for an input device comprising a keyboard 20, a key (e.g., alphabet key 22) may include a shaft 52 or other mechanism for contacting a switch 54 or contact to record presses of the key 22 as is known. A dome 56 or other resilient member (such as a spring, or the like) may cause the shaft 52 and key 22 to return to an initial or un-pressed state. Keyboard 20 may also include a base 58 and a cover 62. In accordance with disclosed embodiments, a touch sensor 30 may be included on a touch sensor substrate 50 that is positioned in between the keyboard cover 62 and the base 58. Though not illustrated in FIG. 4, one of ordinary skill in the art having the benefit of this disclosure would understand that touch sensor substrate 50 may be suspended, supported, or otherwise anchored to not interfere with the operation of switch 54 and dome 56 or other resilient member and the normal operation of the keys 22. Likewise, touch sensor substrate 50 includes apertures 51 or other pass-throughs, contacts, or the like to enable presses of the keys 22 to properly operate the switch 54 and dome 56 or other contact mechanisms. Further, keyboard cover 62 is shown spaced above touch sensor substrate 50 for ease of illustration but may be in contact with touch sensor substrate 50, may be in the same plane as the substrate 50, may have openings to allow the keys 22 to contact the substrate 50, or the like. It is also understood that the touch sensor substrate 50 may be combined with the base 58 into one substrate, or they may be laminated together as a composite substrate, or the like.

Touch sensor substrate 50 may comprise a printed circuit board (PCB), a flexible printed circuit (FPC), conductive ink printed on a flexible surface (e.g., mylar), an in-mold conductive plastic sensor, or the like. As also indicated schematically, a touch sensor 30 may be included on the top surface of the touch sensor substrate 50. As also indicated, touch sensor 30 may comprise a number of electrodes (e.g., 12, 14) that are etched, printed, or otherwise positioned on the top surface of touch sensor substrate 50. As better illustrated in FIG. 5, the electrodes (e.g., 12, 14) are routed to avoid the apertures 51 and shaft 52 and not impede the normal operation of the keys 22 and switches 54.

FIG. 5 is a schematic illustration of an input device of the type shown in FIG. 4 showing exemplary electrode routing for capacitive touch sensors in accordance with disclosed embodiments. FIG. 5 is a simplified schematic showing a mutual capacitance electrode layout to sense individual finger locations. As discussed herein, tighter or looser spacing, different pitch, and different layouts may also be used. As shown, an exemplary input device may be a keyboard 20 that is positioned over a touch sensor substrate 50. As shown, touch sensor substrate 50 may include a number of apertures 51 to enable key shafts or other mechanisms to contact switches for key presses. As also shown, a number of row electrodes 12 (dotted lines) and column electrodes 14 (dashed lines) may be located on the substrate 50 to provide touch or proximity sensing as disclosed herein. As shown in FIG. 5, the electrodes 12, 14 generally surround the locations of each key of the keyboard 20 so that when the keyboard 20 is in place above the touch sensor substrate 50 a determination of which keys have been touched, or which keys the fingers are located near, can be made as disclosed herein. While the electrodes 12, 14 in FIG. 5 are generally shown as a rectangular layout, they need not be so, and other patterns may be implemented. For example, the column electrodes 14 may be a continuous electrode that is routed in a step-wise fashion as exemplarily indicated at electrodes 14A, or the electrodes 14 may be of a more free-form layout as indicated at electrodes 14B, or the electrodes may be free-form or step-wise but be laid out in other directions as indicated at 14C and 14D respectively. Similarly, column electrodes 14 may be laid out generally straight and row electrodes 12 may be laid out step-wise, free-form, or the like. Again, other patterns and electrode layouts may also be implemented. As indicated schematically, a main bus or other connector 64 may be used to connect the various electrodes 12, 14 to a touch controller or other component systems (not shown in FIG. 5).

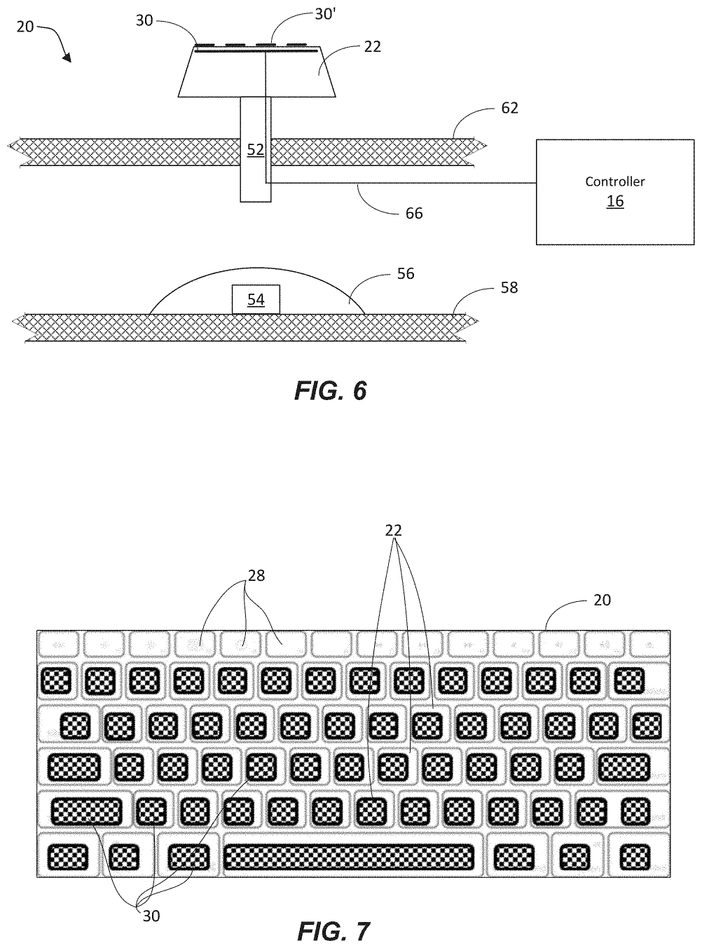

FIG. 6 is an exploded, schematic, cross-sectional illustration of a portion of an input device with capacitive touch sensors in accordance with disclosed embodiments. As shown in close-up, for an input device comprising a keyboard 20, a key (e.g., alphabet key 22) may include a shaft 52 or other mechanism for contacting a switch 54 or contact to record presses of the key 22 as is known. A dome 56 or other resilient member (such as a spring, or the like) may cause the shaft 52 and key 22 to return to an initial or un-pressed state. Keyboard 20 may also include a base 58 and a cover 62. In accordance with disclosed embodiments, a touch sensor 30 may be included within each key 22. In other embodiments, a touch sensor 30′ may be included on top of or overlaying each key 22. In still other embodiments a touch sensor (e.g., 30′) may be included as part of the top surface of each key 22 as, for example, a portion of in-mold conductive plastic or the like. In any case, a flexible or otherwise moveable connection 66 may connect each touch sensor 30, 30′ with a touch controller 16 and may operate in a self-capacitance, mutual capacitance, or mixed mode.

FIG. 7 is a schematic diagram of an input device of the type shown in FIG. 6 showing exemplary locations of capacitive touch sensors in accordance with disclosed embodiments. As shown, an input device comprising a keyboard 20 may have a touch sensor 30 on or within each key 22 for finger sensing. As also indicated, some keys (e.g., function keys 28) may not have touch sensors 30 as desired.

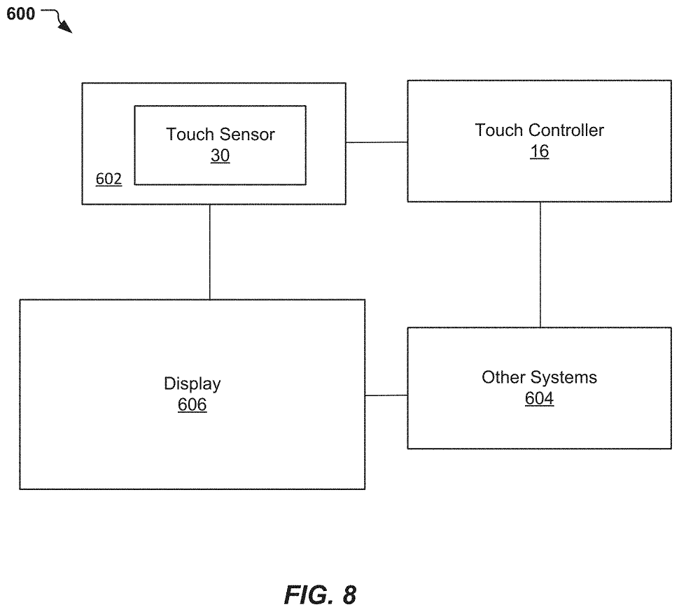

FIG. 8 is a schematic diagram of a system 600 implementing a VR or AR input device with capacitive touch sensing in accordance with disclosed embodiments. As indicated, system 600 may include an input device 602 (e.g., keyboard 20, game controller 40, or the like) that includes a touch sensor 30 as disclosed herein. Touch sensor 30 is in communication with touch controller 16 to enable various touch and proximity sensing functions as disclosed herein. As also indicated, touch sensor 30, input device 602, and touch controller 16 are also in communication with other control systems 604 that may comprise parts of the AR or VR system (e.g., other processors, processor-based devices, controllers, audio systems, input/output devices, or the like) and display 606 which may be a headset or the like worn by a user.

As a person of ordinary skill in the art having the benefit of this disclosure would understand, one advantage of the system 600 is that touches or proximity of hands and fingers on the input device 602 are sensed by touch sensor 30 and communicated to the display 606 so that the user may virtually “see” or otherwise receive and indication of hand and finger positions in the VR or AR environment. The system 600 may show the input device 602 as it appears in reality (e.g., to enable typing or the like), may incorporate the input device 602 into the AR or VR environment (e.g., displaying the input device 602 as a tool, weapon, game object, or the like on display 606), or combinations thereof as dictated by the VR or AR environment.

Although various embodiments have been shown and described, the present disclosure is not so limited and will be understood to include all such modifications and variations would be apparent to one skilled in the art.

What is claimed is:

1. An input device for a Virtual Reality (VR) or Augmented Reality (AR) system, the input device comprising:
at least one input controller for providing user input to the VR or AR system; and
a touch sensor adjacent to the at least one input controller and configurable to sense an object touching or proximate to the at least one input controller.

2. The input device of claim 1 wherein the input device further comprises a keyboard and the at least one input controller comprises a key.

3. The input device of claim 2 wherein the touch sensor is located beneath the key.

4. The input device of claim 2 wherein the touch sensor is located within the key.

5. The input device of claim 2 wherein the touch sensor is located on a top surface of the key.

6. The input device of claim 5 wherein the touch sensor comprises in-mold conductive plastic.

7. The input device of claim 2 wherein the keyboard further comprises:
a wrist rest region; and
a second touch sensor located within the wrist rest region and configurable to sense an object touching or proximate to the wrist rest region.

8. The input device of claim 7 wherein the second touch sensor further comprises a capacitive touch sensor.

9. The input device of claim 1 wherein the touch sensor further comprises a capacitive touch sensor.

10. The input device of claim 1 wherein the input device further comprises a game controller and the at least one input controller comprises a button.

11. The input device of claim 2 wherein the touch sensor comprises at least one electrode beneath the key.

12. A keyboard comprising:
a plurality of keys; and
a touch sensor associated with each of the plurality of keys and that senses a touch or proximity of a user's finger on specific ones of the plurality of keys.

13. The keyboard of claim 12 wherein the touch sensor further comprises:
a touch sensor substrate positioned beneath the plurality of keys; and
a plurality of electrodes on the touch sensor substrate and positioned to substantially outline a perimeter of each of the plurality of keys.

14. The keyboard of claim 12 wherein the touch sensor associated with each of the plurality of keys is incorporated into each of the plurality of keys.

15. A game controller for a Virtual Reality (VR) or Augmented Reality (AR) system, the game controller comprising:
at least one input controller for providing user input to the VR or AR system; and
a touch sensor adjacent to the at least one input controller and configurable to sense an object touching or proximate to the at least one input controller.

16. The game controller of claim 15 wherein the at least one input controller comprises a button.

17. The game controller of claim 16 wherein the touch sensor is located within the button.

18. The game controller of claim 16 wherein the touch sensor is located on a top surface of the button.

19. The game controller of claim 18 wherein the touch sensor comprises in-mold conductive plastic.

20. The game controller of claim 15 wherein the at least one input controller comprises a joystick.
